(19) United States
(12) Patent Application Publication
(10) Pub. No.: US 2021/0396534 A1
(43) Pub. Date: Dec. 23, 2021

(54) INFORMATION PROCESSING DEVICE AND COMPUTER READABLE STORAGE MEDIUM

(71) Applicant: HONDA MOTOR CO.,LTD., Tokyo (JP)

(72) Inventors: Takeshi SAITO, Tokyo (JP); Masashi ETO, Tokyo (JP); Takashi OHTA, Tokyo (JP); Tomohiro SHIBATA, Tokyo (JP)

(21) Appl. No.: 17/346,301

(22) Filed: Jun. 14, 2021

(30) Foreign Application Priority Data
Jun. 18, 2020 (JP) 2020-105282

(51) Int. Cl. G01C 21/34; G01C 21/36

(52) U.S. Cl. CPC G01C 21/3469; G01C 21/3476; G01C 21/3617

(57) ABSTRACT

Provided is an information processing device comprising: a travelling route determining unit configured to determine a travelling route of an electric vehicle; and a route navigation executing unit configured to search a charge stand based on the travelling route and a congestion degree map indicating a congestion degree of people in a target area including the travelling route, and execute route navigation for the electric vehicle based on a search result. The route navigation executing unit may search a charge stand in an area, where the congestion degree is higher than a predetermined threshold, within the target area.

The contents of the following Japanese application are incorporated herein by reference:
NO. 2020-105282 filed in JP on Jun. 18, 2020.

### BACKGROUND

### 1. Technical Field

The present invention relates to an information processing device and a computer readable storage medium.

### 2. Related Art

Patent Document 1 describes a technique for changing information related to a charge stand presented to a user, according to a congestion condition. Patent Document 2 describes a technique for selecting a charge stand according to a route and a vacancy condition of a charge stand.

### PRIOR ART DOCUMENTS

### Patent Documents

[Patent Document 1] WO 2012/160665

[Patent Document 2] WO 2016/006057

### BRIEF DESCRIPTION OF THE DRAWINGS

FIG. 1 schematically shows one example of a system 10.

FIG. 2 schematically shows one example of a target area 50.

FIG. 3 schematically shows one example of a functional configuration of the in-vehicle device 200.

FIG. 4 schematically shows one example of a processing flow by the in-vehicle device 200.

FIG. 5 schematically shows one example of route navigation by a route navigation executing unit 210.

FIG. 6 schematically shows one example of a functional configuration of a management server 300.

FIG. 7 schematically shows one example of a hardware configuration of a computer 1200 configured to function as the in-vehicle device 200 or the management server 300.

### DESCRIPTION OF EXEMPLARY EMBODIMENTS

Hereinafter, the present invention will be described through embodiments of the invention, but the following embodiments do not limit the claimed invention. Moreover, not all combinations of features described in the embodiments are necessary to solutions of the invention.

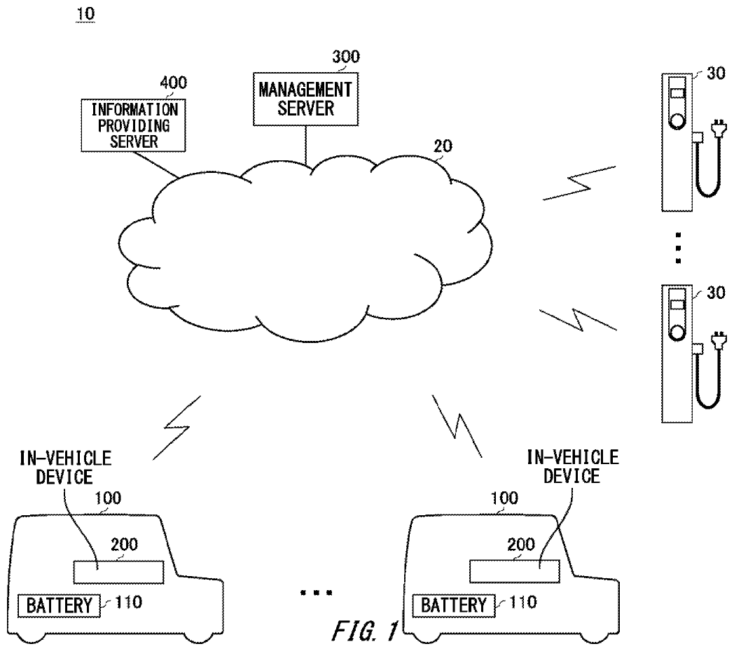

FIG. 1 schematically shows one example of a system 10. The system 10 includes in-vehicle devices 200 and a management server 300. The system 10 may include electric vehicles 100. The system 10 may include charge stands 30.

Each of the in-vehicle devices 200 is mounted in one of the electric vehicles 100. The electric vehicle 100 includes a battery 110. The electric vehicle 100 is a vehicle that can travel by using electrical power from the battery 110. The electric vehicle 100 is a vehicle that can charge the battery 110 by one of the charge stands 30. For example, the electric vehicle 100 is configured to receive electrical power from the charge stand 30 via a charge plug of the charge stand 30, and charge the battery 110.

The in-vehicle device 200 can communicate with the management server 300. The in-vehicle device 200 may communicate with the management server 300 via a network 20.

The network 20 may be any network. For example, the network 20 includes a mobile communication network such as the so-called 3G (3rd Generation), LTE (Long Term Evolution), 4G (4th Generation), and 5G (5th Generation). The network 20 may include the so-called Wi-Fi (registered trademark) (Wireless Fidelity) network. The network 20 may include the Internet.

The in-vehicle device 200 may access the network 20 via a wireless base station by cellular communication. The in-vehicle device 200 may access the network 20 via a Wi-Fi access point by Wi-Fi communication.

The management server 300 may collect vehicle related information related to the electric vehicle 100 from the in-vehicle device 200. The vehicle related information may include location information indicating a location of the electric vehicle 100. The vehicle related information may include battery information indicating a remaining capacity of the battery 110. For example, the battery information indicates a SOC (State Of Charge).

The vehicle related information may include destination information indicating a destination of the electric vehicle 100. For example, the destination information may indicate a destination that is set in a navigation system of the electric vehicle 100. The vehicle related information may include travelling route information indicating a travelling route of the electric vehicle 100. For example, he travelling route information of the electric vehicle 100 may be route information that is set in the navigation system of the electric vehicle 100.

The vehicle related information may include occupant related information related to an occupant of the electric vehicle 100. The occupant related information may include information about a hobby of the occupant. The occupant related information may include information about a liking of the occupant.

The management server 300 is configured to collect stand related information related to the charge stand 30 from the charge stand 30. The management server 300 may communicate with the charge stand 30 via the network 20.

The charge stand 30 may have a wired connection to the network 20. The charge stand 30 may access the network 20 via a wireless base station by cellular communication. The charge stand 30 may access the network 20 via a Wi-Fi access point by Wi-Fi communication.

The stand related information may include location information indicating a location of the charge stand 30. The stand related information may include a possible number of simultaneous charging. For example, the possible number of simultaneous charging is the number of charge connectors. The stand related information may include charge capability information indicating a charge capability of the charge stand 30. For example, the charge capability may be a chargeable amount per unit time. The stand related information may include stand congestion information indicating a congestion degree of charging in the charge stand 30. For example, the stand congestion information may be the number of waiting vehicles. In addition, the stand congestion information may be information such as congested, normal, vacant.

The management server 300 may communicate with an information providing server 400. The management server 300 may communicate with the information providing server 400 via the network 20. The management server 300 may receive information provided by the information providing server 400. For example, the management server 300 may receive, from the information providing server 400, a congestion degree map indicating a congestion degree of people in each location.

For example, the information providing server 400 is configured to generate the congestion degree map by collecting location information of a mobile communication terminal such as a mobile phone and using the location of the mobile communication terminal as the location of a person. The information providing server 400 may collect the location information of the mobile communication terminal from each of a plurality of mobile communication terminals. For example, the information providing server 400 may receive the location information of the mobile communication terminal via an application installed in the mobile communication terminal. The information providing server 400 may collect the location information of the plurality of mobile communication terminals from a communication carrier. The information providing server 400 may receive the location information of the plurality of mobile communication terminals from a location information management server configured to manage the location information of the plurality of mobile communication terminals.

The congestion degree map may include upload location information indicating a location where an image is uploaded by the mobile communication terminal. For example, the information providing server 400 is configured to collect location information when the image is uploaded from each of the plurality of mobile communication terminals. The information providing server 400 may collect upload location information of each of the plurality of mobile communication terminals from the communication carrier.

The management server 300 may generate a congestion degree map. The management server 300 may generate the congestion degree map by using information collected from the plurality of in-vehicle devices 200. For example, the management server 300 is configured to generate the congestion degree map by using the location of the electric vehicle 100 as the location of a person. The management server 300 may generate the congestion degree map by using the location information of the plurality of mobile communication terminals collected from the information providing server 400 and the location information of the electric vehicles 100 collected from the plurality of in-vehicle devices 200.

The management server 300 may receive, from the information providing server 400, event related information related to an event held at each location. The event related information may include information of a venue of the event. The event related information may include information of a type of the event.

The information providing server 400 may store the event related information of an event held at each location and send the event related information to the management server 300 in response to a request from the management server 300. For example, the event related information may be registered by an event sponsor, an event participant or the like.

The in-vehicle device 200 according to the present embodiment is configured to determine a travelling route of the electric vehicle 100 (which may be described as the own vehicle) having the in-vehicle device 200 mounted thereon, search a charge stand based on the travelling route and a congestion degree map in a target area including the travelling route, and execute route navigation for the own vehicle based on the search result. The in-vehicle device 200 may be one example of an information processing device.

The travelling route of the own vehicle may be a route to a destination that is set in a navigation for the own vehicle. In addition, the travelling route may be a recommended route selected from a plurality of candidate routes to the destination of the own vehicle. In addition, the travelling route may be a candidate route to the destination of the own vehicle.

For example, the in-vehicle device 200 is configured to estimate a travelable distance by the own vehicle, based on a remaining amount of the battery 110. The in-vehicle device 200 is configured to determine a target area including the travelling route, when the in-vehicle device 200 judges that charging is required before reaching the destination. For example, the in-vehicle device 200 is configured to determine, as the target area, a range within a predetermined distance in relation to the travelling route.

The in-vehicle device 200 may determine a timing when charging is required based on the remaining amount of the battery 110, and determine the target area further based on the timing. For example, the in-vehicle device 200 determines, as the timing when charging is required, a timing when the remaining amount of the battery 110 becomes lower than a predetermined threshold, in a case where the electric vehicle 100 travels the travelling route. Then, the in-vehicle device 200 determines, as the target area, an area in relation to a location of the electric vehicle 100 at the timing when charging is required.

The in-vehicle device 200 may acquire a congestion degree map in the target area from the management server 300. Then, the in-vehicle device 200 searches a charge stand based on the congestion degree map, and executes the route navigation for the own vehicle based on the search result.

For example, the in-vehicle device 200 searches a charge stand in an area, where the congestion degree of people is higher than a predetermined threshold, within the target area. Thus, the own vehicle can be guided to a charge stand where some store is located nearby or a charge stand where some event is held nearby, and this can contribute to the occupant of the own vehicle in that the occupant of the own vehicle can spend the time during charging of the own vehicle meaningfully. In addition, this can prevent the own vehicle to be guided to a charge stand settled in an area where there are almost no people around, for example, an rural area, and can reduce the possibility that the occupant of the own vehicle has to spend his/her time tediously during charging of the own vehicle or stay in an area with poor public security.

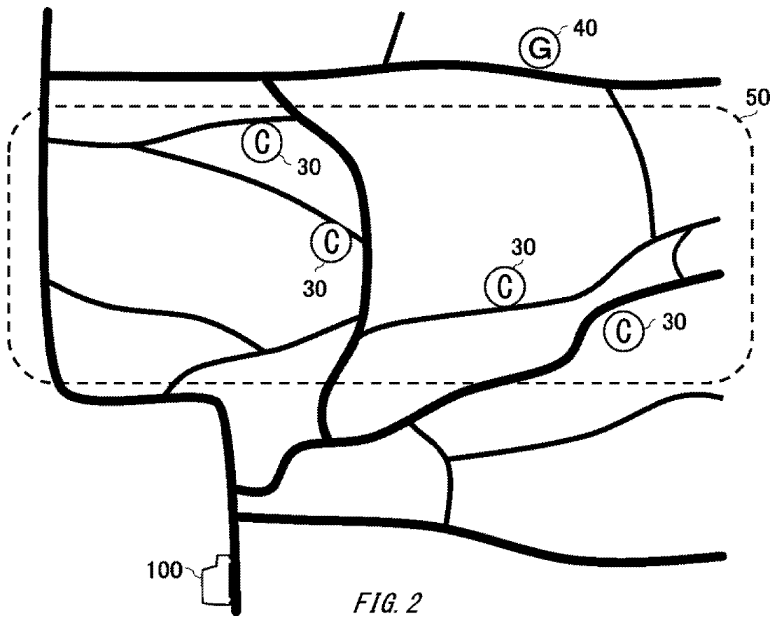

FIG. 2 schematically shows one example of a target area 50. For example, the management server 300 is configured to decide the target area 50 based on a travelling route from a location of the electric vehicle 100 to a destination 40 of the electric vehicle 100 and a remaining amount of the battery 110 of the electric vehicle 100. Herein, an example is described where the travelling route includes a plurality of candidate routes.

The in-vehicle device 200 may receive a congestion degree map in the target area 50 from the management server 300. The in-vehicle device 200 may search a charge stand 30 based on the travelling route and the congestion degree map, and execute the route navigation for the electric vehicle 100 based on the search result.

For example, the in-vehicle device 200 is configured to select one charge stand 30 from a plurality of charge stands 30, and execute the route navigation for the electric vehicle 100 to travel a route involving use of the selected charge stand 30. For example, the in-vehicle device 200 is configured to select a charge stand 30 having a highest congestion degree of people. In addition, the in-vehicle device 200 may select one charge stand 30 from the plurality of charge stands 30 by further using other information. For example, the in-vehicle device 200 is configured to select one charge stand 30 by giving priority to a charge stand 30, which has a low congestion degree of charging, among the plurality of charge stands 30 in an area where the congestion degree of people is higher than a predetermined threshold, by excluding a charge stand 30 at a location that the occupant of the electric vehicle 100 shows no interest in, or by giving priority to a charge stand 30 where an event is held nearby.

The in-vehicle device 200 may select, from the plurality of charge stands 30, a plurality of charge stands 30 as candidates, and execute the route navigation presenting a plurality of routes involving use of each of the plurality of charge stands 30 to the occupant of the electric vehicle 100. For example, the in-vehicle device 200 is configured to execute the route navigation presenting a congestion degree of people in an area where the charge stand 30 is located, for each of the plurality of routes. For example, the occupant of the electric vehicle 100 may select, from the presented plurality of candidates, a route involving use of the charge stand 30 in an area having a higher congestion degree of people.

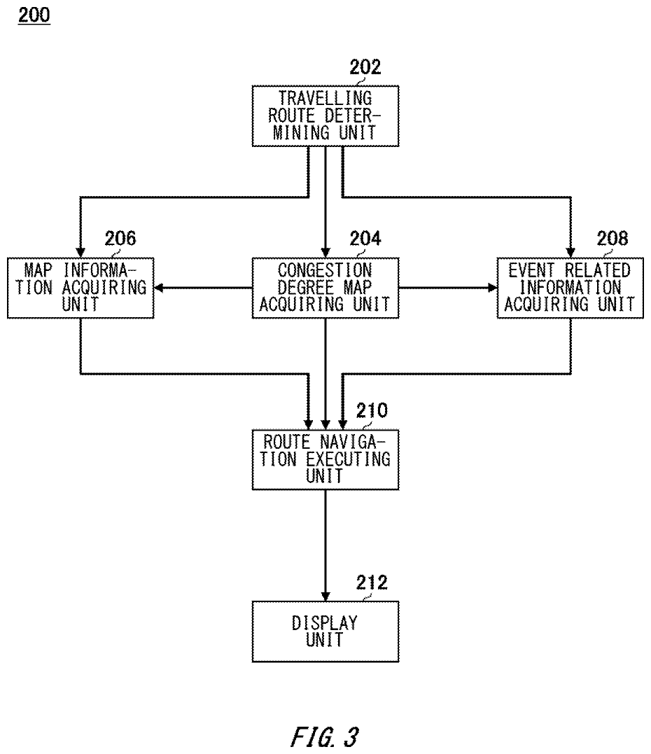

FIG. 3 schematically shows one example of a functional configuration of the in-vehicle device 200. The in-vehicle device 200 includes a travelling route determining unit 202, a congestion degree map acquiring unit 204, a map information acquiring unit 206, an event related information acquiring unit 208, a route navigation executing unit 210, and a display unit 212.

The travelling route determining unit 202 is configured to determine a travelling route of the own vehicle. For example, the travelling route determining unit 202 is configured to determine a set route to a destination that is set in the navigation system of the own vehicle as the travelling route. In addition, for example, the travelling route determining unit 202 is configured to determine a plurality of candidate routes to the destination of the own vehicle as the travelling route. In addition, for example, the travelling route determining unit 202 is configured to determine a recommended route selected from the plurality of candidate routes as the travelling route.

The congestion degree map acquiring unit 204 is configured to acquire a congestion degree map of a target area 50 including a travelling route determined by the travelling route determining unit 202. For example, the congestion degree map acquiring unit 204 is configured to send vehicle related information including the travelling route determined by the travelling route determining unit 202 to the management server 300, and receive the congestion degree map of the target area 50 including the travelling route from the management server 300. In addition, for example, the congestion degree map acquiring unit 204 is configured to inform the management server 300 about the target area 50 including the travelling route determined by the travelling route determining unit 202, and receive a congestion degree map of the target area 50 from the management server 300.

The map information acquiring unit 206 is configured to acquire map information of the target area 50. The map information may include information of buildings or the like. For example, the map information acquiring unit 206 is configured to acquire map information of the target area 50 from a pre-stored nationwide map information. The map information acquiring unit 206 may inform the management server 300 about the target area 50, and receive map information of the target area 50 from the management server 300.

The event related information acquiring unit 208 is configured to acquire event related information of the target area 50. For example, the event related information acquiring unit 208 is configured to inform the management server 300 about the target area 50, and receive event related information of the target area 50 from the management server 300.

The route navigation executing unit 210 is configured to execute the route navigation for the own vehicle. The route navigation executing unit 210 may search a charge stand 30 based on a travelling route determined by the travelling route determining unit 202 and a congestion degree map acquired by the congestion degree map acquiring unit 204, and execute the route navigation for the own vehicle based on the search result. The route navigation executing unit 210 may execute the route navigation by using a display output and an audio output by the display unit 212.

The route navigation may include providing information related to the set route to the destination to the occupant of the own vehicle. The information related to the set route may include information of a charge stand 30 on the set route. The route navigation may include selecting a recommended route from a plurality of candidate routes to the destination of the own vehicle. The route navigation may include providing the occupant of the own vehicle with information of the recommended route selected from the plurality of candidate routes. The route navigation may include providing the occupant of the own vehicle with information of the plurality of candidate routes.

The route navigation executing unit 210 is configured to search a charge stand 30 in an area, where the congestion degree of people is higher than the predetermined threshold, within the target area 50. A relatively high congestion degree of people means that it is highly likely that there is some store nearby or some event is held nearby. Therefore, searching such charge stand 30 can contribute to the occupant of the own vehicle in that the occupant of the own vehicle can spend the time during charging of the own vehicle meaningfully.

For example, the route navigation executing unit 210 is configured to decide a recommended charge stand for the own vehicle based on the search result, and execute the route navigation about a route including a location of the recommended charge stand. When the search result includes a plurality of charge stands 30, the route navigation executing unit 210 may decide priority between the plurality of charge stands 30 based on the congestion degree of people in the area where each of the plurality of charge stands 30 is positioned. The route navigation executing unit 210 may execute the route navigation presenting information of the congestion degree of people in the area where the searched one charge stand 30 or each of the plurality of charge stands 30 is positioned.

For example, the route navigation executing unit 210 is configured to select, among the charge stands 30 in the target area 50, a charge stand 30 having a highest congestion degree of people in the area where the charge stand 30 is positioned, and execute the route navigation of a route involving use of the selected charge stand 30. For example, the route navigation executing unit 210 is configured to select, among the charge stands 30 in the target area 50, a plurality of charge stands 30 in an area where the congestion degree of people is higher than the predetermined threshold, and execute the route navigation performing a presentation to the occupant including the congestion degree of people in the area where each of the plurality of charge stands 30 is positioned.

The route navigation executing unit 210 may execute the route navigation by giving priority to a charge stand 30 having a lower congestion degree of charging at the charge stand 30, among the plurality of charge stands 30 in an area, where the congestion degree of people is higher than the predetermined threshold, within the target area 50. For example, the route navigation executing unit 210 is configured to select a charge stand 30 having a lowest congestion degree of charging among the plurality of charge stands 30, and execute the route navigation of a route involving use of the selected charge stand 30. For example, the route navigation executing unit 210 is configured to execute the route navigation by ordering, and presenting to the occupant, the routes in the order of ascending congestion degrees of charging at the charge stands 30.

The route navigation executing unit 210 may execute the route navigation by excluding a charge stand at a location registered in advance as a location that the occupant of the own vehicle shows no interest in, among the plurality of charge stands 30 in an area, where the congestion degree of people is higher than the predetermined threshold, within the target area 50. Thus, possibility that the own vehicle is guided to an charge stand 30 in an area that has a high congestion degree of people but the occupant shows no interest in, such as a charge stand 30 positioned near a school or a charge stand 30 positioned near a company, can be reduced.

The route navigation executing unit 210 may execute the route navigation by giving priority to a charge stand at a location related to the destination of the own vehicle, among the plurality of charge stands 30 in an area, where the congestion degree of people is higher than the predetermined threshold, within the target area 50. For example, the route navigation executing unit 210 is configured to determine a location related to the destination of the own vehicle, based on event related information acquired by the event related information acquiring unit 208. For example, when the destination of the own vehicle is a hotel in an tourist site, the route navigation executing unit 210 executes the route navigation by giving priority to a charge stand 30 in an area where an event related to a tourist attraction in the tourist site is held. Thus, the own vehicle can be guided to the charge stand 30 at the location suited for the purpose of the occupant, and this can contribute to the occupant in that the occupant can spend the time during charging of the own vehicle meaningfully.

The route navigation executing unit 210 may execute the route navigation by giving priority to a charge stand 30 located at the venue of an event, among the charge stands 30 in an area, where the congestion degree of people is higher than the predetermined threshold, within the target area 50. The route navigation executing unit 210 may determine a charge stand 30 located at the venue of an event, based on event related information acquired by the event related information acquiring unit 208.

The route navigation executing unit 210 may search a charge stand 30 by giving priority to an area, where the number of image upload is higher, within the target area 50, based on upload location information included in the congestion degree map. For example, the route navigation executing unit 210 selects, among charge stands 30 within the target area 50, a charge stand 30 located in an area where the number of image upload is highest, and executes the route navigation of a route involving use of the charge stand 30. In addition, for example, the route navigation executing unit 210 executes the route navigation ordering, and presenting to the occupant, the plurality of charge stands 30 within the target area 50 in the order of descending numbers of image upload in the area where each of the plurality of charge stands 30 is positioned. It is highly likely that a location having a high number of image upload is a location that people tend to be interested in, such as a tourist spot. Thus, the occupant can be guided to the charge stand 30 near the location that the occupant tends to be interested in, and this can contribute to the occupant in that the occupant can spend the time during charging of the own vehicle meaningfully.

The route navigation executing unit 210 may predict an arrival time when the own vehicle arrives at each of the plurality of charge stands 30 included in the target area 50, and decide a charge stand to be included in the search result based on the congestion degree of people at the arrival time in the area where each of the plurality of charge stands 30 is positioned. Thus, possibility that a situation happens where the electric vehicle 100 arrives at an area that is empty, although a great number of people were there at the time of search, can be reduced.

Note that, the route navigation executing unit 210 may be configured to search a charge stand 30 in an area, where the congestion degree of people is lower than the predetermined threshold, within the target area 50. This can be satisfy the needs of an occupant who desires to spend the charging time of the electric vehicle 100 as quietly as possible or an occupant who desired to use a charge stand 30 that is probably less congested, even if there is less people around, or the like.

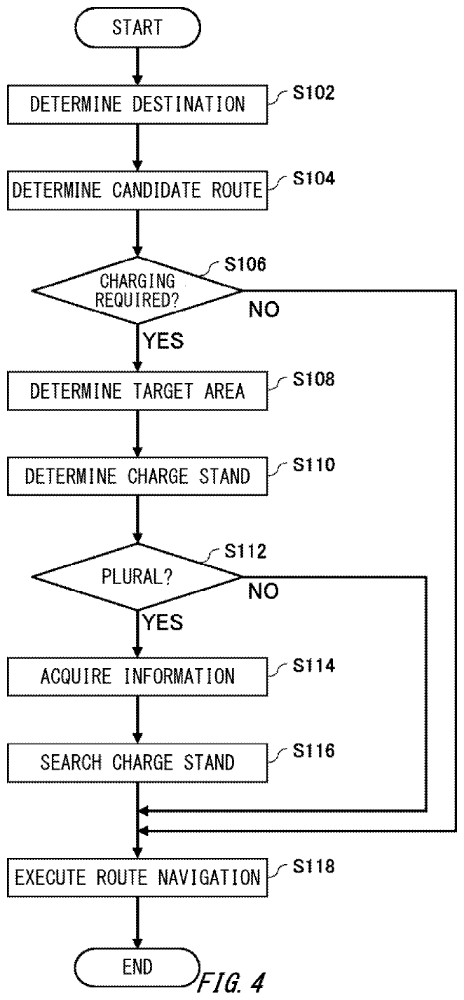

FIG. 4 schematically shows one example of a processing flow by the in-vehicle device 200. In the description here, the starting state is the state where the destination is set by the occupant of the electric vehicle 100.

At Step (Step may be abbreviated as S) 102, the travelling route determining unit 202 determines a destination of the electric vehicle 100. At S104, the travelling route determining unit 202 decides a candidate route to the destination. At S106, the travelling route determining unit 202 judges whether charging is required in the middle of the way in order to travel to the destination, based on the remaining amount of the battery 110 of the electric vehicle 100. When it is judged that charging is required, the process proceeds to S108. When it is judged that no charging is required, the process proceeds to S118, and the route navigation executing unit 210 executes route navigation involving no charging in the middle of the way.

At S108, the travelling route determining unit 202 determines a target area 50 including the candidate route. At S110, the travelling route determining unit 202 determines a charge stand 30 in the target area 50. At S112, it is judged whether the charge stand 30 determined at S110 includes a plurality of charge stands 30. When the charge stand 30 determined at S110 includes a plurality of charge stands 30, the process proceeds to S114. When the charge stand 30 determined at S110 does not include a plurality of charge stands 30, the process proceeds to S118, and the route navigation executing unit 210 executes route navigation of a route involving use of the determined charge stand 30.

At S114, the in-vehicle device 200 acquires related information. For example, the congestion degree map acquiring unit 204 acquires a congestion degree map of the target area 50. In addition, the map information acquiring unit 206 may acquire map information of the target area 50. In addition, the event related information acquiring unit 208 may acquire event related information of the target area 50.

At S116, the route navigation executing unit 210 searches a charge stand 30 based on the information acquired at S114. At S118, the route navigation executing unit 210 executes the route navigation for the electric vehicle 100 based on the search result at S116.

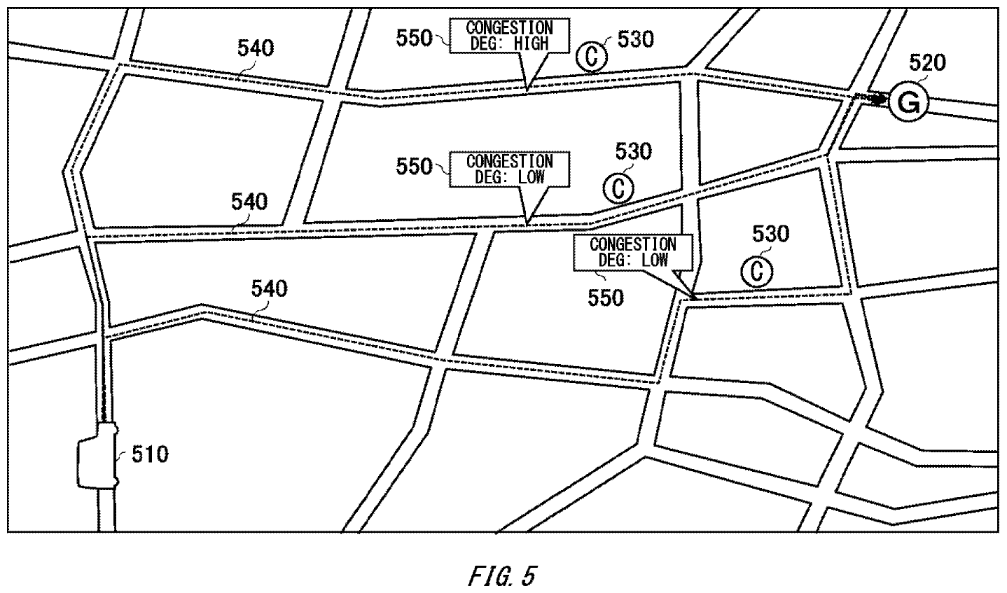

FIG. 5 schematically shows one example of route navigation by a route navigation executing unit 210. FIG. 5 describes the route navigation by performing display that reflects the congestion degree of people in the area where the charge stand 30 is positioned, for each of the plurality of candidate routes to the destination.

The route navigation executing unit 210 may provide display including an own vehicle object 510 indicating the own vehicle, a destination object 520 indicating the destination, a charge stand object 530 indicating the charge stand 30, a candidate route object 540 indicating the candidate route, and a congestion degree object 550 indicating the congestion degree of people in the area the charge stand 30 is positioned. The route navigation executing unit 210 may control so as to perform display of the candidate route object 540 on which the charge stand object 530, which indicates one charge stand 30 or each of a plurality of charge stands 30 included in the search result, and the congestion degree object, which indicates the congestion degree of people at the one charge stand or each of the plurality of charge stands, are reflected as illustrated in FIG. 5.

FIG. 5 illustrates a case where the congestion degree object 550 indicates that the congestion degree of people is high, medium, or low, but it is not limited thereto. The congestion degree object 550 may indicate the congestion degree of people at a more detailed level and may also indicate a numerical value of the population density or the like.

The route navigation executing unit 210 may cause display of the charge stand object 530 or the candidate route object 540 according to the congestion degree of people in the area where the charge stand 30 is positioned, instead of the display of the congestion degree object 550 or along with the display of the congestion degree object 550. For example, the route navigation executing unit 210 cause display of the charge stand object 530 more emphasized as the congestion degree of people is higher. In addition, for example, the route navigation executing unit 210 may cause display of the candidate route object 540 more emphasized as the congestion degree of people is higher.

In FIG. 1 to FIG. 5, a case is described as an example where the in-vehicle device 200 mainly executes the route navigation, but it is not limited thereto. The management server 300 may mainly execute the route navigation.

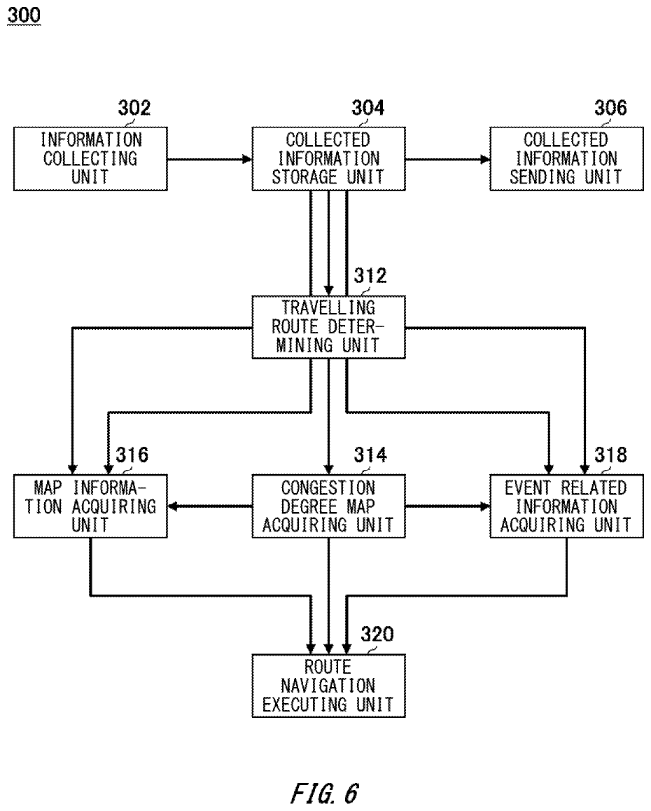

FIG. 6 schematically shows one example of a functional configuration of the management server 300. The management server 300 includes an information collecting unit 302, a collected information storage unit 304, a collected information sending unit 306, a travelling route determining unit 312, a congestion degree map acquiring unit 314, a map information acquiring unit 316, an event related information acquiring unit 318, and a route navigation executing unit 320. The management server 300 may be one example of the information processing device.

The information collecting unit 302 is configured to collect various types of information. The information collecting unit 302 is configured to collect vehicle related information from the electric vehicle 100. In addition, the information collecting unit 302 is configured to collect stand related information from the charge stand 30. In addition, the information collecting unit 302 is configured to collect a congestion degree map from the information providing server 400. In addition, the information collecting unit 302 is configured to collect event related information from the information providing server 400. The information collecting unit 302 is configured to store the collected information in the collected information storage unit 304.

The collected information sending unit 306 is configured to send the collected information stored in the collected information storage unit 304 to the in-vehicle device 200. The collected information sending unit 306 may send the various types of collected information to the in-vehicle device 200 in response to a request from the in-vehicle device 200.

The travelling route determining unit 312 is configured to determine a travelling route of the electric vehicle 100 that will be a target of executing the route navigation (which may be described as the target vehicle). The determining method may be similar to that of the travelling route determining unit 202.

The congestion degree map acquiring unit 314 is configured to acquire a congestion degree map of a target area 50 including a travelling route determined by the travelling route determining unit 312. For example, the congestion degree map acquiring unit 314 is configured to acquire a part corresponding to the target area 50 from a nationwide congestion degree map stored in the collected information storage unit 304.

The map information acquiring unit 316 is configured to acquire map information of the target area 50. For example, the map information acquiring unit 316 is configured to acquire map information of the target area 50 from pre-stored nationwide map information.

The event related information acquiring unit 318 is configured to acquire event related information of the target area 50. For example, the event related information acquiring unit 318 is configured to acquire a part corresponding to the target area 50 from a nationwide event related information map that is stored in the collected information storage unit 304.

The route navigation executing unit 320 is configured to execute route navigation for the target vehicle. The route navigation executing unit 320 may search a charge stand 30 based on a travelling route determined by the travelling route determining unit 312 and a congestion degree map acquired by the congestion degree map acquiring unit 314, and execute the route navigation for the target vehicle based on the search result. The route navigation executing unit 320 may execute the route navigation for the target vehicle by sending display data or sending a display instruction to the target vehicle. The method of route navigation may be similar to that of the route navigation executing unit 210.

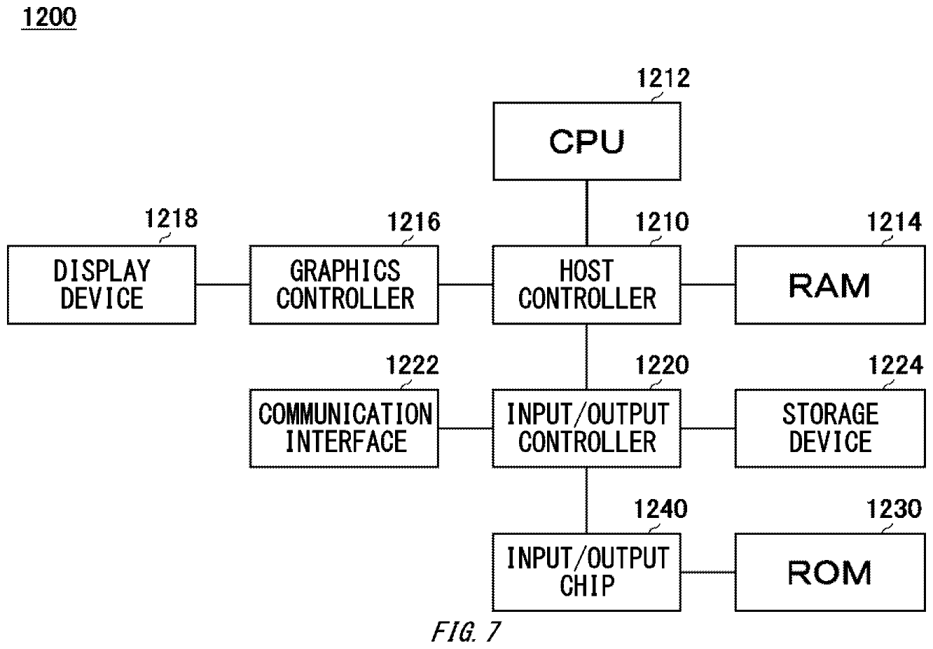

FIG. 7 schematically indicating one example of a hardware configuration of a computer 1200 configured to function as the in-vehicle device 200 or the management server 300. A program that is installed in the computer 1200 can cause the computer 1200 to function as one or more “units” of apparatuses of the present embodiments or perform operations associated with the apparatuses of the present embodiments or the one or more units, and/or can cause the computer 1200 to perform processes of the present embodiments or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage device 1224, a DVD drive and an IC card drive, which are connected to the host controller 1210 via an input/output controller 1220. The DVD drive may be a DVD-ROM drive, a DVD-RAM drive, etc. The storage device 1224 may be a hard disk drive, a solid-state drive, etc. The computer 1200 also includes legacy input/output units such as a ROM 1230 and a keyboard, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on a display device 1218.

The communication interface 1222 communicates with other electronic devices via a network. The storage device 1224 stores programs and data used by the CPU 1212 within the computer 1200. The DVD drive reads the programs or the data from the DVD-ROM or the like, and provides the storage device 1224 with the programs or the data. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port or the like to the input/output controller 1220.

A program is provided by a computer readable storage medium such as the DVD-ROM or the IC card. The program is read from the computer readable storage medium, installed into the storage device 1224, RAM 1214, or ROM 1230, which are also examples of a computer readable storage medium, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffer region provided in a recording medium such as the RAM 1214, the storage device 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage device 1224, the DVD drive (DVD-ROM), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, information processing, condition judging, conditional branch, unconditional branch, search/replacement of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry whose attribute value of the first attribute matches the condition a designated condition, from among the plurality of entries, and read the attribute value of the second attribute stored in the entry, thereby obtaining the attribute value of the second attribute associated with the first attribute satisfying the predetermined condition.

The above described program or software modules may be stored in the computer readable storage medium on or near the computer 1200. In addition, a recording medium such as a hard disk or a RAM provided in a server system connected to a dedicated communication network or the Internet can be used as the computer readable storage medium, thereby providing the program to the computer 1200 via the network.

Blocks in flowcharts and block diagrams in the present embodiments may represent steps of processes in which operations are performed or “units” of apparatuses responsible for performing operations. Certain steps and “units” may be implemented by dedicated circuitry, programmable circuitry supplied with computer readable instructions stored on a computer readable storage medium, and/or processors supplied with computer readable instructions stored on a computer readable storage medium. Dedicated circuitry may include digital and/or analog hardware circuits and may include integrated circuits (IC) and/or discrete circuits. For example, programmable circuitry may include reconfigurable hardware circuits including logical AND, OR, XOR, NAND, NOR, and other logical operations, flip-flops, registers, and memory elements, such as field-programmable gate arrays (FPGA), programmable logic arrays (PLA), etc.

A computer readable storage medium may include any tangible device that can store instructions for execution by a suitable device, such that the computer readable storage medium having instructions stored therein comprises an article of manufacture including instructions which can be executed to create means for performing operations specified in the flowcharts or block diagrams. Examples of the computer readable storage medium may include an electronic storage medium, a magnetic storage medium, an optical storage medium, an electromagnetic storage medium, a semiconductor storage medium, etc. More specific examples of the computer readable storage medium may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer readable instructions may be provided to a processor of a general purpose computer, special purpose computer, or other programmable data processing apparatus, or to programmable circuitry, locally or via a local area network (LAN), wide area network (WAN) such as the Internet, etc., so that the processor of the general purpose computer, special purpose computer, or other programmable data processing apparatus, or the programmable circuitry executes the computer readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: system, 20: network, 30: charge stand, 40: destination, 50: target area, 100: electric vehicle, 110: battery, 200: in-vehicle device, 202: travelling route determining unit, 204: congestion degree map acquiring unit, 206: map information acquiring unit, 208: event related information acquiring unit, 210: route navigation executing unit, 212: display unit, 300: management server, 302: information collecting unit, 304: collected information storage unit, 306: collected information sending unit, 312: travelling route determining unit, 314: congestion degree map acquiring unit, 316: map information acquiring unit, 318: event related information acquiring unit, 320: route navigation executing unit, 400: information providing server, 510: own vehicle object, 520: destination object, 530: charge stand object, 540: candidate route object, 550: congestion degree object, 1200: computer, 1210: host controller, 1212: CPU, 1214: RAM, 1216: graphics controller, 1218: display device, 1220: input/output controller, 1222: communication interface, 1224: storage device, 1230: ROM, 1240: input/output chip

What is claimed is:

1. An information processing device comprising;
a travelling route determining unit configured to determine a travelling route of an electric vehicle; and
a route navigation executing unit configured to search a charge stand based on the travelling route and a congestion degree map indicating a congestion degree of people in a target area including the travelling route, and execute route navigation for the electric vehicle based on a search result.

2. The information processing device according to claim 1, wherein the route navigation executing unit is configured to search the charge stand in an area, where the congestion degree is higher than a predetermined threshold, within the target area.

3. The information processing device according to claim 2, wherein the route navigation executing unit is configured to execute the route navigation by giving priority to a charge stand having a low congestion degree of charging at the charge stand, among charge stands in the area, where the congestion degree is higher than the predetermined threshold, within the target area.

4. The information processing device according to claim 2, wherein the route navigation executing unit is configured to execute the route navigation by excluding a charge stand at a location registered in advance as a location that an occupant of the electric vehicle shows no interest in, among charge stands in the area, where the congestion degree is higher than the predetermined threshold, within the target area.

5. The information processing device according to claim 3, wherein the route navigation executing unit is configured to execute the route navigation by excluding a charge stand at a location registered in advance as a location that an occupant of the electric vehicle shows no interest in, among the charge stands in the area, where the congestion degree is higher than the predetermined threshold, within the target area.

6. The information processing device according to claim 2, wherein the route navigation executing unit is configured to execute the route navigation by giving priority to a charge stand at a location related to a destination of the electric vehicle, among charge stands in the area, where the congestion degree is higher than the predetermined threshold, within the target area.

7. The information processing device according to claim 3, wherein the route navigation executing unit is configured to execute the route navigation by giving priority to a charge stand at a location related to a destination of the electric vehicle, among charge stands in the area, where the congestion degree is higher than the predetermined threshold, within the target area.

8. The information processing device according to claim 1, wherein the route navigation executing unit is configured to execute the route navigation by giving priority to a charge stand located at a venue of an event, among charge stands in the area, where the congestion degree is higher than a predetermined threshold, within the target area.

9. The information processing device according to claim 2, wherein the route navigation executing unit is configured to execute the route navigation by giving priority to a charge stand located at a venue of an event, among charge stands in the area, where the congestion degree is higher than the predetermined threshold, within the target area.

10. The information processing device according to claim 1,
wherein the congestion degree map includes upload location information indicating a location where an image is uploaded by each of a plurality of mobile communication terminals within the target area, and
wherein the route navigation executing unit is configured to search the charge stand by giving priority to an area having a higher number of image upload within the target area, based on the upload location information.

11. The information processing device according to claim 2,
wherein the congestion degree map includes upload location information indicating a location where an image is uploaded by each of a plurality of mobile communication terminals within the target area, and
wherein the route navigation executing unit is configured to search the charge stand by giving priority to an area having a higher number of image upload within the target area, based on the upload location information.

12. The information processing device according to claim 1, wherein the route navigation executing unit is configured to decide a recommended charge stand for the electric vehicle based on the search result, and execute the route navigation about a route including a location of the recommended charge stand.

13. The information processing device according to claim 2, wherein the route navigation executing unit is configured to decide a recommended charge stand for the electric vehicle based on the search result, and execute the route navigation about a route including a location of the recommended charge stand.

14. The information processing device according to claim 1, wherein, when the search result includes a plurality of charge stands, the route navigation executing unit is configured to decide priority between the plurality of charge stands, based on the congestion degree of people in an area where each of the plurality of charge stands is positioned.

15. The information processing device according to claim 1, wherein the route navigation executing unit is configured to execute the route navigation presenting information of the congestion degree of people in an area where searched one charge stand or each of a plurality of charge stands is positioned.

16. The information processing device according to claim 15, wherein the route navigation executing unit is configured to control so as to perform display of a route object indicating the travelling route of the electric vehicle on which a stand object, which indicates the one charge stand or each of the plurality of charge stands included in the search result, and a congestion degree object, which indicates the congestion degree of people at the one charge stand or each of the plurality of charge stands, are reflected.

17. The information processing device according to claim 1, wherein the route navigation executing unit is configured to predict an arrival time when the electric vehicle arrives at each of a plurality of charge stands included in the target area, and decide a charge stand included in the search result, based on the congestion degree of people at the arrival time in an area where each of the plurality of charge stands is positioned.

18. The information processing device according to claim 1, wherein the route navigation executing unit is configured to search the charge stand in an area, where the congestion degree is lower than a predetermined threshold, within the target area.

19. A non-transitory computer readable storage medium having stored thereon a program for causing a computer to function as:
a travelling route determining unit configured to determine a travelling route of an electric vehicle; and
a route navigation executing unit configured to search a charge stand based on the travelling route and a congestion degree map indicating a congestion degree of people in a target area including the travelling route, and execute route navigation for the electric vehicle based on a search result.
